(19) United States
(12) Patent Application Publication
(10) Pub. No.: US 2010/0207036 A1
(43) Pub. Date: Aug. 19, 2010

(54) OPTICAL IMAGING DEVICE

(75) Inventors: Marc Massonneau, Tillieres Sur Avre (FR); Pascale Parrein, Fontaine (FR)

Correspondence Address: OLIFF & BERRIDGE, PLC, P.O. BOX 320850, ALEXANDRIA, VA, 22320-4850, US

(73) Assignee: QUIDD, Mont Saint Aignan (FR)

(21) Appl. No.: 12/304,076

(22) PCT Filed: Jun. 13, 2007
(86) PCT No.: PCT/FR2007/051433

§ 371 Date: Mar. 19, 2010

(30) Foreign Application Priority Data
Jun. 14, 2006 (FR) 0652517

(51) Int. Cl. G01N 21/64

(52) U.S. Cl. 250/459.1; 250/458.1

(57) ABSTRACT

The invention concerns an optical imaging device for a human or animal body, including: an optical sensing system, a drive system of at least one light collector from the optical sensing system, permitting modification of at least the position and/or direction, and a control system from the drive system, arranged so as to lead the light collector from the optical sensing system to at least one observation situation of at least one chosen region of the body to be examined, based on data concerning its topology.

The present invention relates to optical imaging devices, and more specifically, but not exclusively, to those intended for imaging small animals.

The invention relates in particular to devices in which the body to be observed receives one or more photoluminescent probes, detection being carried out by means of an optical detection system when the body is optionally illuminated so as to cause fluorescence of the probes.

Many optical imaging devices for small animals have already been proposed. U.S. Pat. No. 6,894,289 discloses an imaging device in which a camera is mounted fixedly on the top of a compartment inside which the animal is positioned.

International application WO 03/006966 A1 discloses an imaging device in which the animal is placed on an elongated support, movable along two axes, observation being carried out by means of a camera via a mirror rotating about an axis parallel to the longitudinal axis of the support. The topology of the animal is also acquired. The presence of a mirror does not allow near field acquisition and in addition this is not always carried out in the orientation most favorable for detection.

Other imaging devices are disclosed in the publications WO 2005/043138 A1 and WO 02/41760 A2. In the latter application the received light is carried by a bundle of optical fibers through to a camera. The animal is immersed in a liquid between two transparent plates, which proves to be impractical.

WO 2006/033064 discloses a device for imaging the human cranium in which a 3D reconstruction takes place from images acquired by the device.

There is a need to benefit from a new optical imaging device having satisfactory sensitivity and resolution, and which is practical to use.

The subject of the invention, according to one of its aspects, is an optical imaging device for human or animal body imaging, comprising:

a support for receiving the body to be examined;

an optical detection system, in particular a camera;

a drive system for driving at least one light collector of the optical detection system, allowing at least the position and/or orientation thereof to be modified; and

a control system for controlling the drive system, set up so as to bring, in particular automatically, the light collector of the optical detection system into at least one situation for observing at least one chosen area of the body, depending on data relating to the topology of the latter.

When the optical detection system comprises a camera, this may be completely mobile and movable by the drive system, for example being carried by an arm of the drive system.

The light collector of the optical detection system may be defined by a light inlet in the detection system, for example a light inlet face in an objective of the camera or through one end of at least one optical guide collecting the light to be analyzed.

The control system may be set up so as to cause the optical detection system to cover a surface of the area to be examined of between 1 and 5 cm², for example. In this way, a relatively precise image of the selected area may be obtained.

In addition the mobility of the optical detection system may in particular enable the control system to position the light collector relatively close to the body to be observed, for example at a distance of less than 9 cm from this body, which is advantageous from the point of view of resolution and sensitivity.

The drive system may comprise three displacement axes that are perpendicular in pairs.

Finally, the mobility of the optical detection system may facilitate the observation of areas until now difficult to observe with known imaging devices.

The control system may be set up so as to position automatically the optical detection system with an optical axis thereof approximately perpendicular to the area of the body to be examined. This positioning operation may be carried out using knowledge of the topological data relating to the body to be observed.

The control system may be set up to calculate automatically the position and orientation to be given to the light inlet in the optical detection system in order to observe a selected area of the body.

The optical detection system may comprise a camera, as mentioned above, or any other photosensitive detector, optionally in association with one or more optical guides and/or light amplifiers. The detection system may comprise several juxtaposed light amplifiers.

The imaging device may comprise at least one filter placed in the light path between the animal and at least one part of the optical detection system, especially a plurality of filters, for example a plurality of filters carried by a wheel, which enables one filter to be replaced easily by another. The wheel may be controlled by the control system, for example using a motorized drive.

The filter(s) may be of the interference filter type. In a variant, at least one wavelength-tunable filter is used, for example a liquid crystal tunable filter (LCTF) or an acousto-optic tunable filter.

The filter(s) may be low-pass, high-pass or bandpass filters.

The filter(s) used may be chosen so as selectively to allow through only light emitted by one or more probes, and not the possible fluorescence excitation light.

If necessary, the detection may be synchronous with the illumination so as to improve the signal/noise ratio.

In the case in which the optical detection system comprises a camera, the filter(s) may be placed in front of the camera objective or between the objective and the camera or even be integrated in the objective. When the filter is placed between the objective and the camera, this may enable a reduction in size and in the distance between the objective and the area of the body to be examined.

When the optical detection system comprises a camera, this may be equipped with a telecentric objective.

The camera may be equipped with an objective having a depth of field greater than that of conventional objectives, for example greater than or equal to 0.5 cm, and a constant enlargement over a wide working range.

The use of a telecentric objective may enable the combination of several sequentially acquired images of adjacent areas of the body of the animal. The use of a telecentric objective also enables priority to be given to the collection of rays parallel to the optical axis and limits filter losses from the filter(s) used.

The support for the body to be observed may be movable or stationary, preferably being movable along an axis, which may facilitate the construction of the support structure for the optical detection system.

When the latter comprises a camera, this may be part of a vision unit also comprising the objective, the optional filtering system and all or part of an optional illumination system.

At least the camera, and preferably the entire vision unit, is movable, for example along at least two approximately mutually perpendicular translation axes and about a rotation axis, for example, approximately parallel to the displacement axis of the support on which the animal is placed.

The optical imaging device may furthermore comprise a topology acquisition system, allowing the provision of data describing the topology of the observed body to the control system of the drive system.

The topology acquisition system may comprise a camera, which, for example, is the same as that of the optical imaging device, or in a variant a different camera.

If necessary, the topology acquisition system comprises drive means for moving the support on which the animal is placed relative to a topology analysis system.

These drive means are, for example, the same as those used by the imaging device, the support on which the animal is placed being, for example, movable between the topology acquisition system and the imaging system.

The support on which the animal is placed may comprise at least one detector sensitive to a movement by the animal relative to the support.

The imaging device may be set up to warn the user of a movement of the animal relative to the support, for example by generating an audible or visual alarm. If necessary, the imaging device may be set up automatically to initiate a new cycle of acquiring the topology of the animal and/or of matching topological data with the observed data in the case of detecting a movement of this animal relative to the support.

The detector sensitive to movement of the animal may comprise one or more pads on which the animal rests, equipped with at least one pressure sensor. The pad(s) may serve, if necessary, to transport a fluid enabling the support to be heated.

The control system may be set up so as to enable an extended analysis of the observed body by controlling the optical detection system so as to carry out a sequence of near field observations with a movement of the optical detection system between each of the observations.

When the optical detection system comprises a camera, the control system may be set up to control the camera so as automatically to take several successive views of the body so as to reconstruct a more global view.

The imaging device may comprise at least one source for illuminating the body with radiation having a predefined spectral characteristic.

The source(s) used may be monochromatic or polychromatic, laser, electroluminescent or discharge sources, for example xenon-mercury sources, optionally of adjustable power.

The light coming from at least one source may be carried toward the body to be examined by means of at least one optical guide, especially one or more optical fibers. The source(s) and/or the optional optical guide(s) may be joined to the aforementioned vision unit.

The light may be injected into the optical guide(s) by means of a focusing system.

At least one filter may be placed in the path of the light intended to illuminate the body, for example in order to eliminate the infrared radiation and/or essentially to allow through only the light intended to excite the fluorescence.

An automated filter wheel comprising several interference filters may be inserted between the source(s) and the aforementioned focusing system. The light exiting the optical fiber(s) may be collimated, focused or diverging, according to needs.

The body to be observed may be illuminated from several locations.

The body may, for example, be illuminated from the ends of several optical fibers pointing in different directions, these optical fibers being able, for example, to meet in a common beam illuminated by a common source.

The illumination system may at least partly accompany the optical detection system in its movement, ensuring an approximately homogeneous and constant illumination over a given area. When using a camera, a mechanical system for positioning the source(s) and/or optional optical guide(s) may ensure that the illumination can be adapted to the enlargement of the camera objective and the repeatability of illumination between experiments.

The imaging device may comprise a user interface configured to allow the user to select at least one area of observation on the body.

This user interface may comprise a screen enabling a 3D image of the body to be displayed and selection means enabling selection of the area to be observed, which can be made to appear on the 3D image of the body.

The user interface may allow the user to select an operational mode among the following three modes of operation:

automatic movement of the light collector depending on data relating to the topology;

movement of the light collector depending on manually input coordinates; or

movement of the light collector, along at least one axis, in response to the actuation of a manual movement control device.

The device may comprise an approximately monochromatic illumination source for illuminating the human or animal body, the device being without a closed, light-proof chamber positioned between the user and the human or animal body.

The 3D image may be generated from data about the topology of the animal.

The optical imaging device may, in an exemplary implementation of the invention, according to preference operate in at least one of the following ways:

enable imaging by fluorescence, by reflectance or from bioluminescence; or

enable tomographic imaging.

The subject of the invention is also, according to another of its aspects, an imaging method, for example for tomographic imaging, especially of a small animal, comprising the step consisting in:

acquiring at least one image of a photoluminescence with the optical detection system of the device as defined further above.

The image acquisition may be preceded by or be simultaneous with the illumination of at least one area of the body so as to cause photoluminescence.

The body may be that of a small animal such as a rodent, with observation taking place after injection in this animal of at least one fluorescent probe or after the expression of a gene coding a photoluminescent protein, for example a fluorescent protein.

Before acquiring the photoluminescence, the topology of the body may be acquired.

The subject of the invention is also, according to another of its aspects, independently of or in combination with the above, a human or animal body imaging device comprising:

a support for receiving the body to be examined;

a camera, for example a camera belonging to a vision unit also comprising an objective, a filtering system and optionally an illumination system;

a drive system allowing at least the position and/or orientation of the body relative to the camera to be modified, by movement either of the support, or of the camera, or of both;

a control system for the drive system; and

a user interface comprising a screen on which a 3D image at least partly representing the animal may be displayed, the interface enabling selection of an area on this image, and the control device being set up to automatically cause the camera to observe the selected area on the image.

The selected area may in particular appear highlighted or be in a different color on the image.

The subject of the invention is also, according to another of its aspects, independently of or in combination with the above, a human or animal body imaging device comprising:

a support for receiving the body to be examined, the latter having received at least one probe;

an illumination system for exciting the probe;

an optical detection system, especially comprising a camera, the optical detection system being associated with a system for filtering the light coming from the body to be examined;

a drive system allowing at least the position and/or orientation of the body relative to at least part of the optical detection system to be modified;

a control system for the drive system; and

a user interface set up to display simultaneously on the same screen:

the spectrum of the probe excitation light emitted by the illumination system;

the emission spectrum of the probe; and

the spectrum of the filtering system.

Such a display assists the interpretation of results by allowing the user to have an overall vision of the spectral conditions of image acquisition.

The subject of the invention is also, according to another of its aspects, independently of or in combination with the above, a human or animal body imaging device comprising:

a support for receiving the body to be examined;

an optical detection system, especially comprising a camera;

a drive system allowing at least the position and/or orientation of the body relative to at least part of the optical detection system to be modified;

a control system for the drive system; and

an illumination system for illuminating the observed area, comprising a focusing system, which may be automatic, for focusing the light onto the observed area depending on a field of observation of the optical detection system.

For example, the illumination system comprises at least one light projection head, the orientation of which is automatically controlled depending, for example, on a selected enlargement or on the distance to the observed region of a light inlet into the optical detection system.

The invention will be able to be understood better on reading the following detailed description of nonlimiting exemplary implementations of the invention, and on examining the appended drawing, in which:

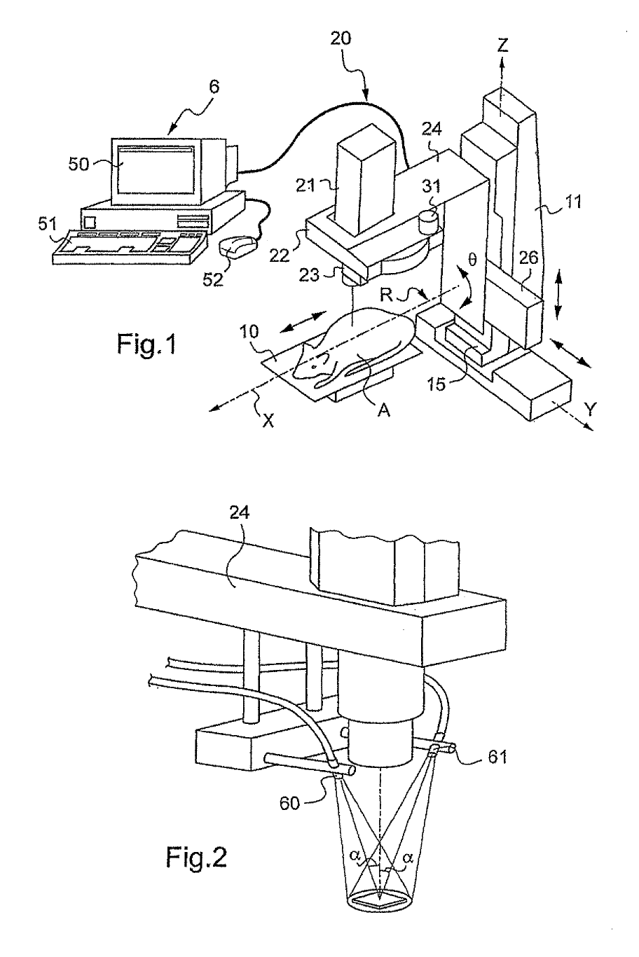

FIG. 1 is an overall schematic view of an example of the device according to the invention;

FIG. 2 partly represents an example of the illumination system;

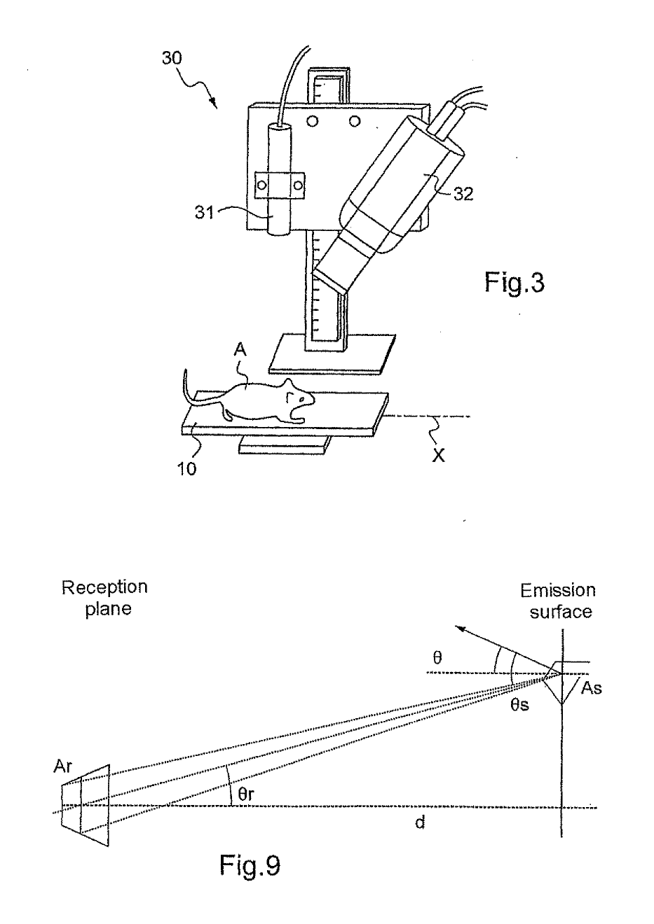

FIG. 3 represents on its own an example of a topology acquisition system;

FIGS. 4 to 8 are examples of pages displayed by the screen of the user interface;

FIG. 9 is a diagram to illustrate the calculation of the collected light flux; and

FIG. 10 represents a detail of the production of a variant of the device.

FIG. 1 represents an imaging device 1 according to an exemplary implementation of the invention.

This device 1 comprises an imaging system 20 and a computer system 6 which comprises, in the example illustrated, a microcomputer, for example of the PC type, but which could comprise other data processing means, for example one or more specialized electronic cards, optionally integrated into the imaging system 20.

The device 1 may require working in an environment that is dark or includes inactinic light not interfering with the acquisition of the photoluminescence. For example, the device may comprise illumination with blue LED diodes, of wavelength 470 nm, of the part in which the imaging system 20 is placed, the latter being without a closed, light-proof compartment in which the animal would be placed. This may facilitate connection of the animal A to instruments.

In the example considered, the device 1 is designed for imaging a small animal A, for example a rodent, and the latter may be positioned, as illustrated in FIG. 1, on a support 10, which may be able to be moved in translation along an axis X. Its movement may be controlled by the computer system 6.

The animal A may be connected to instruments that are not shown, of the respiratory assistance type, to a gas anesthesia system, to a catheter, or to sensors like a thermometer, an electrocardiograph, etc.

The support 10 may optionally comprise a heating system so as to be maintained at a predefined temperature, for example close to that of the animal A, when this is alive.

The support 10 may comprise at least one detector allowing a movement of the animal A to be detected, for example one or more pads provided with at least one pressure sensor and on which the animal A rests. A movement of the animal A relative to the support may thus be detected and the imaging device can warn the user of this and/or update the topological data and/or carry out a new matching of topological data and imaging data.

The imaging system 20 comprises, in the example considered, a vertical column 11 with axis Z, carried by a carriage 15 which can slide horizontally along an axis Y perpendicular to the aforementioned axis X.

The imaging system 20 also comprises an optical detection system composed, in the example considered, of a vision unit carried by an arm 24 which can turn about a horizontal rotation axis R, carried by a carriage 26 able to move along the Z axis on the column 11.

The axis of rotation R is advantageously parallel to the axis X of movement of the support 10.

The imaging system 20 could, without departing from the scope of the present invention, offer more degrees of freedom of movement and/or orientation. The support 10 could be stationary and the column could be carried by an additional carriage that can be moved along the X axis.

The movements along the axes X, Y and Z and in rotation about the axis R are motorized and controlled by the computer system 6. The latter is thus able to know the relative positions of the support 10 and the vision unit.

This comprises, in the example considered, a camera 21, an objective 23 and a filtering system 22.

The position and the orientation of the camera 21 are known to the computer system 6 and the movements of the camera 21 may be controlled by this computer system.

The filtering system 22 comprises, for example, a wheel. 27 with filters that allows a filter chosen among several to be selectively placed in the path of the light analyzed by the camera 21.

In the example considered, the positioning of the selected filter is carried out automatically, the wheel 27 being rotated by a stepper motor 31 controlled by the computer system 6, a sensor informing the computer system about the angular position of the wheel 27.

The filtering system 22 may comprise, for example, five filters having, for example, a diameter of 5 cm. In the case in which the wheel is placed between the objective and the camera, this may comprise, for example, 7 filters of 2.5 cm diameter.

The invention is not limited to a particular filtering system and the filter wheel illustrated may be replaced by a wavelength-tunable filter.

The camera 21 may be a CCD camera, preferably back-thinned, having a resolution greater than or equal to a million pixels and pixels of a size greater than 10 μm.

The camera 21 may be equipped with a thermoregulation system, through the Peltier effect for example.

The objective 23 has, for example, an enlargement from ×1 to ×0.5 and a focal length equal, for example, to 50 mm, so as to allow a relatively small area, for example with a surface of sides between 1 and 2.3 cm, of the animal A to be placed in the observation field.

The objective 23 is advantageously a telecentric objective.

The imaging system 20 may also comprise an illumination system for illuminating the animal A so as to enable detection of fluorescence coming from one or more fluorescent probes inside this animal.

The wavelength of the light illuminating the animal A and the spectral characteristics of the filtering system will be chosen depending on the probe to be detected.

The animal A is illuminated for example in at least two directions from optical guides, for example optical fibers, which are able to receive the light from a single source.

These optical guides lead, for example, to heads 60 and 61 carried by the arm 24, as illustrated in FIG. 2, and which may be oriented by the user so as to illuminate the animal at a particular incidence a with a possibility, if necessary, of adjusting the orientation in order to modify the angle of incidence a and to focus the light onto the observed area.

If necessary, the angle of incidence a is changed automatically by the computer system 6, depending on the distance of the observed area and/or the enlargement, using motorization of the illumination heads 60 and 61. This may allow the light to be concentrated on the observed area in an automatic manner.

A light filtering system may be associated with the source(s) of the illumination system so as to control the spectral characteristics of the light illuminating the animal A.

The imaging device may also comprise, if necessary, several light sources that are switched on selectively depending on the position of the camera relative to the animal, so as, for example, not to illuminate the animal with sources that might hinder detection of the luminescence.

The positioning of the camera 21 may be carried out automatically using topological data about the animal A so as to place the area to be observed in the field of observation.

These topological data may be obtained in various ways, for example by means of the topology acquisition system 30 illustrated in FIG. 3. This system 30 comprises a device 31 for projecting structured light onto the animal A and at least one camera 32 for acquiring the relief of the animal thus illuminated.

The latter may be mounted, during topological data acquisition, on the same support 10 as that used for imaging.

In the example illustrated, the support 10 is moved in a controlled way along the axis X and the projection system 31 enables projection onto the animal of a line of light oriented transverse to the axis X.

For each position of the support 10 along the axis X, an image of the profile illuminated by the projected line is acquired and the topology of the animal can then be reconstructed by a piece of software, for example by the computer system 6 which then has at least one file containing the topological data of the animal directly available.

In the example illustrated, the topology acquisition system 30 is separate from the imaging system 20, the support 10 passing from one to the other through a movement along the axis X, but in a non-illustrated variant the same camera is used to carry out both the topology acquisition and the imaging, a structured-light projection device then being added to the imaging system 20.

In another variant, the acquisition of topological data takes place when the support 10 has been removed from the imaging device 20 and placed in a topology acquisition system which possesses means of driving the support 10 separate from those of the imaging device 20.

The support 10 may be produced with at least one reference mark that can be identified by the camera 21 so as to facilitate, for example, matching topology data with those coming from the imaging system.

The topology acquisition may also be carried out by laser triangulation.

The computer system 6 is advantageously equipped with a user interface that allows the latter to control the positioning of the camera 21 so as to observe a predefined area of the animal A.

The user interface may comprise a screen 50 and at least one system for inputting information, which may comprise a mouse 52, a joystick, a keyboard 51, a graphics tablet, a stylus or a touchscreen.

The computer system 6 may be set up so as to allow the opening of one or more windows on the screen 50, for example a window 42 relating to the control of the camera and a window 44 relating to the images acquired during imaging, as illustrated in FIG. 4.

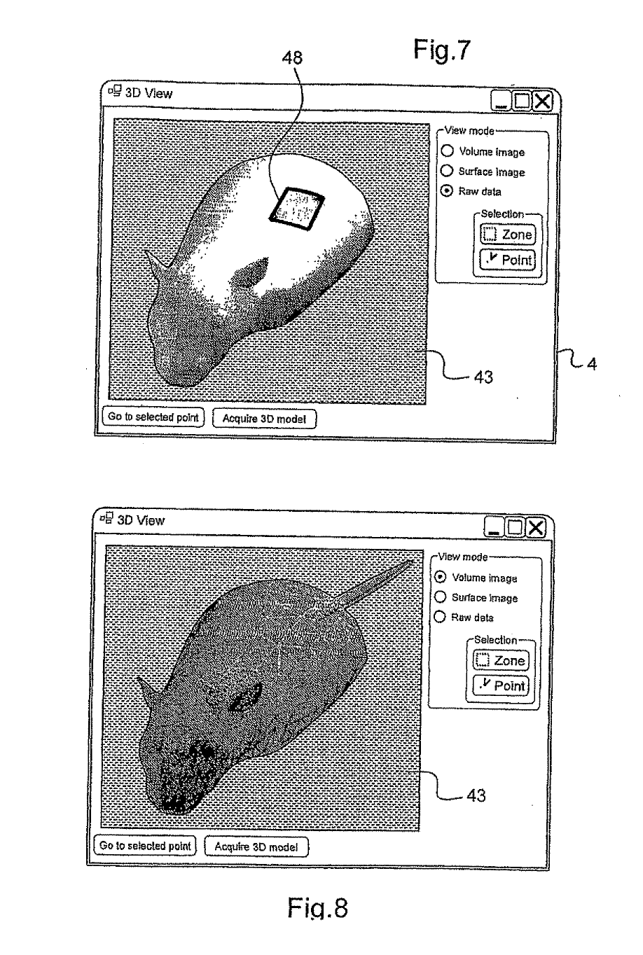

It is also possible to display a window 43 relating to the topology of the animal A, as illustrated in FIGS. 7 and 8, and a window, not shown, in which a scroll-down menu relating to the history of acquired images may appear.

The aforementioned window 42 may contain fields for re-entering coordinates that may be notified by the user, and the computer system 6 may be set up automatically to cause the camera 21 to observe the area centered on the point whose coordinates have been input, the optical axis of the camera being, for example, approximately perpendicular to this point.

The window 42 may, if necessary, allow changes to the camera resolution, the exposure time, the filters selected for the source and for the camera, the enlargement, the distance to the animal, and may optionally allow the user to control manually the movement of the camera in at least one direction relatively in relation to the observed area.

The window 44 may contain the image observed by the camera in real time and a graph showing the number of pixels for each gray level.

The window 43 may allow a sequence of acquiring the topology of the animal to be launched, and may allow a window allowing control of the camera positioning to be opened.

The window 43 may contain a 3D synthetic image of the animal. The area covered by the field of observation of the camera may be marked on this 3D image, for example by highlighting and/or by showing the outline 48 of the area covered by the field of observation of the camera, as illustrated in FIG. 7.

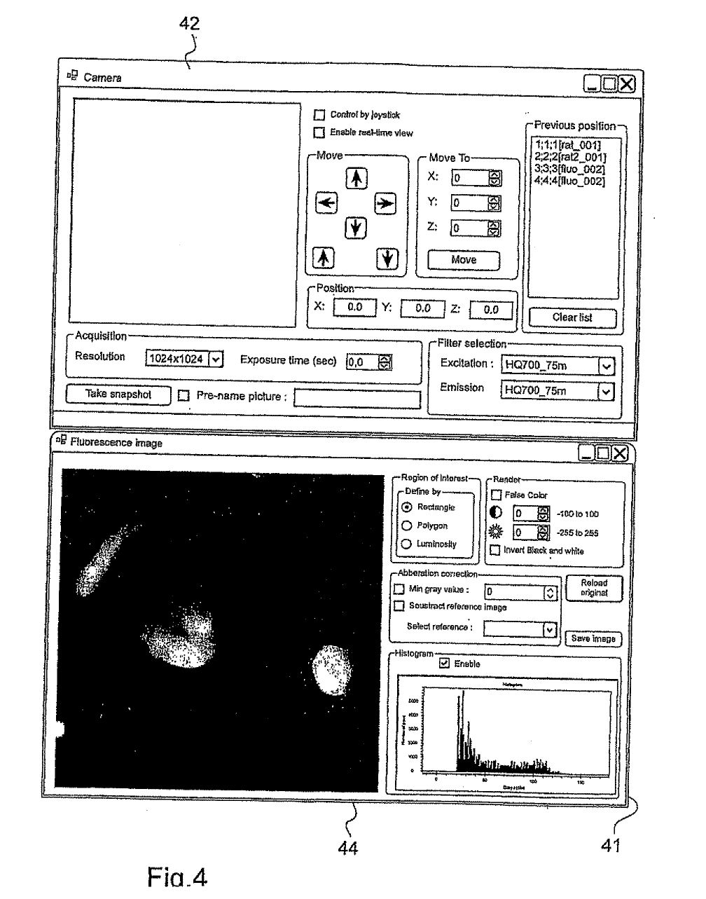

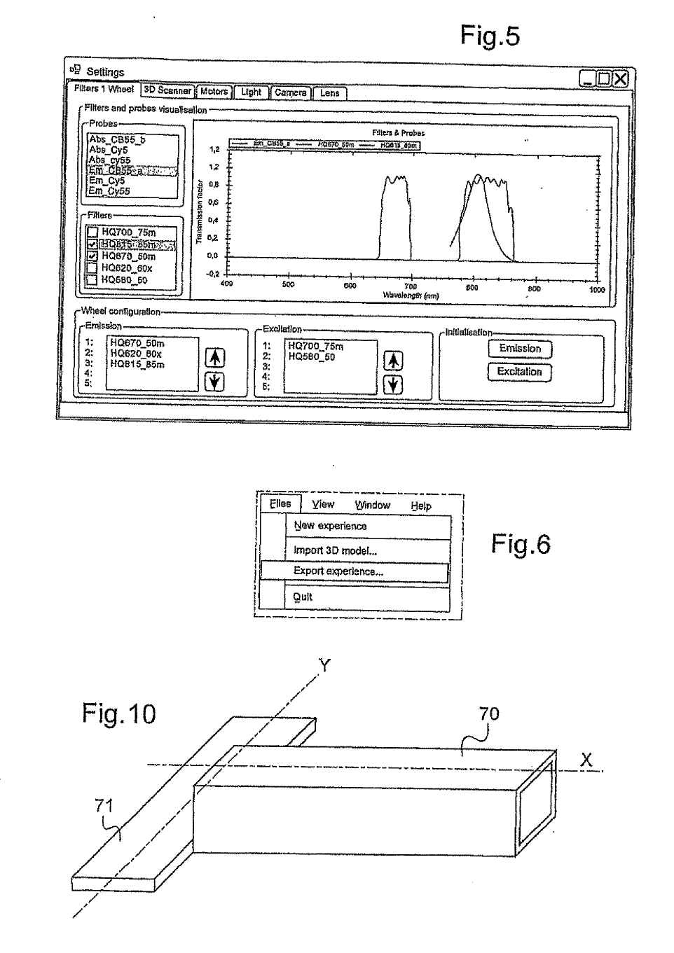

The computer system 6 may be set up so as to allow the matched filter and optionally the particular features of the source, to be stored, depending on a probe, as illustrated in FIG. 5. The spectra of the incident light, of the light emitted by the source and of the filter receiving this light may be displayed simultaneously, as illustrated in FIG. 5.

If necessary the topological data may be imported in a predefined form at into the computer system 6, as illustrated in FIG. 6, these topological data having been obtained, for example, using an acquisition system other than that illustrated in FIG. 3 in the course of another experiment.

Once the luminescence images have been acquired, the computer system 6 may be set up to carry out, if desired, a tomographic reconstruction. This reconstruction makes use of the optical parameters of the system and is based on one or more models enabling the propagation of the luminescence within the animal to its surface to be described.

Without being linked to a particular theory, light propagation in a turbid environment of complex geometry may be described in particular by a direct model. The reconstruction of the position and the intensity of the light source from acquired data is carried out by solving an inverse problem. Photometric calibration may allow a connection to be made between the data acquired by the camera and those resulting from the modeling.

This calibration may allow matching of the local illumination Eₛ (W.m⁻²) to the surface of the sample obtained by modeling with the flux detected at the pixel level.

The emission at the surface of the diffusing sample may be assumed to be Lambertian and can be linked with the source luminescence Lₛ (W.s⁻².sr⁻¹) by:

Eₛ=π·Lₛ (eq.1)

The flux received by a pixel has the value, in W:

$$F ( λ , x , y ) = \frac{q \cdot D ( x , y ) \cdot h \cdot c}{η ( λ ) \cdot λ \cdot T} \qquad ( eq . 2 )$$

where

q is the quantizing step of the camera in e-/level

h is the Planck constant h=6.626 10³⁴J.s

c is the speed of light in a vacuum c=3 10⁸ m.s⁻¹

λ is the wavelength

η is the quantum yield

T is the integration time

D is the maximum gray level—D_{Offset}, and

x and y are the coordinates of the pixel measured.

The flux measured by a pixel (eq. 2) may be considered equal to the flux emitted by the surface Aₛ (eq. 3) and collected by the optical system with an aperture equal to Aᵣ.

$${A}_{s} = {( \frac{u}{m \cdot cos ( {θ}_{r} - {θ}_{s} )} )}^{2} \qquad ( eq . 3 )$$

u is the size of a pixel, and
m is the enlargement of the optical system.

The flux collected at an angle θᵣ, as illustrated in FIG. 9, is linked with the source luminescence Lₛ by:

$${F}_{θ r} = {L}_{s} \cdot {G}_{o} \cdot {cos}^{4} ( {θ}_{r} ) = \frac{{L}_{s} \cdot {A}_{s} \cdot {A}_{r} \cdot {cos}^{4} ( {θ}_{r} )}{{d}^{2}} \qquad ( eq . 4 )$$

where G₀ is the geometric span defined on the optical axis of the system

$$\frac{{A}_{r}}{{d}^{2}} = \frac{1}{{N}^{2}} \qquad ( eq . 5 )$$

where N is the f-number of the system.

The measured flux is linked with the local illumination Es by the following formula (eq.6):

$${F}_{θ r} = \frac{{E}_{s} \cdot {u}^{2} \cdot {cos}^{4} ( {θ}_{r} )}{π \cdot {( m \cdot N \cdot cos ( {θ}_{r} - {θ}_{s} ) )}^{2}} \qquad ( eq . 6 )$$

The invention is not limited to the examples that have just been described.

The imaging device may in particular be used to detect a photoluminescence that would not be caused by the illumination of the animal with a particular light.

The imaging device may optionally comprise a compartment allowing the animal to be isolated from the ambient illumination.

Various changes may be made to the computer system and the connection between this and the camera may be completely wired or wireless.

The imaging device may comprise other means for positioning the camera, for example a manipulator arm.

The invention may also be applied to the imaging of a larger sized animal or even a human.

The imaging device may comprise, if necessary, at least a second camera, the position of which may be controlled by the computer system so as, for example, to refine the location of the probe in the body of the animal.

In the variant illustrated in FIG. 10, the motorized axes X and Y are carried by parts 70 and 71 rigidly coupled to each other.

The X axis is raised in relation to the Y axis, so as to approach the system for acquiring the subject A, thus limiting the movements along the Z axis.

The parts 70 and 71 also allow the stability of the device to be increased.

If necessary, the processing of images and topology data may be carried out in a nonlocalized manner by a server to which the computer system 6 would be connected, the function thereof being, for example, limited to controlling the camera positioning system and the acquisition of images coming from the camera.

The camera of the imaging device may be replaced by a different optical detection system, for example one or more photosensitive detectors, optionally associated with one or more light amplifiers.

If necessary, the optical detection system may comprise a stationary part and a moveable part defining an inlet for the light coming from the animal and the position and/or orientation of which may be changed by the drive system.

The moveable part may comprise an optical guide, for example with one or more optical fibers, the distal end of which, which defines the aforementioned inlet, can be oriented so as to be positioned in the desired way relative to the animal, and the proximal end of which is, for example, stationary and connected to a camera or any other optical detection system.

The expression “comprising a” should be taken to be synonymous with “comprising at least one” unless specified to the contrary.

1. An optical imaging device for human or animal body imaging, comprising:
an optical detection system;
a drive system for driving at least one light collector of the optical detection system, allowing at least the position and/or orientation thereof to be modified; and
a control system for controlling the drive system, set up so as to bring the light collector of the optical detection system into at least one situation for observing at least one chosen area of the body to be examined, depending on data relating to the topology of the latter.

2. The device as claimed in claim 1, the optical detection system comprising a camera.

3. The device as claimed in claim 2, the camera being equipped with a telecentric objective.

4. The device as claimed in claim 1, the control system being set up so as to position the light collector of the detection system at a distance of less than 9 cm from the observed area of the body.

5. The device as claimed in claim 2, the control system being set up so as to position the camera with its optical axis approximately perpendicular to the area of the body to be examined.

6. The device as claimed in claim 2, the control system being set up so as to cause the camera to cover a surface with sides of 1 to 2.3 cm, of the area of the body to be examined.

7. The device as claimed in claim 2, comprising at least one filter placed in front of the camera.

8. The device as claimed in claim 1, comprising a support for the body to be examined which is moveable relative to a support structure of the optical detection system.

9. The device as claimed in claim 1, comprising a topology acquisition system, allowing the provision of data describing the topology of the examined body to the control system.

10. The device as claimed in claim 1, the control system being set up so as to enable an extended observation of the observed area by controlling the optical detection system so as to carry out a sequence of near field observations with a movement of the optical detection system between each of the observations.

11. The device as claimed in claim 1, comprising a user interface configured to allow the user to select at least one area of observation on the body.

12. The device as claimed in claim 1, comprising at least one source for illuminating the body with radiation having a predefined spectral characteristic.

13. The device as claimed in claim 1, being set up to enable imaging by fluorescence, by reflectance or from bioluminescence, or tomographic imaging, these two modes of operation being offered by the device.

14. The device as claimed in claim 1, the drive system comprising three displacement axes that are perpendicular in pairs.

15. The device as claimed in claim 11, the user interface allowing the user to select an operational mode among the three following modes:
automatic movement of the light collector depending on data relating to the topology;
movement of the light collector depending on manually input coordinates; or
movement of the light collector, along at least one axis, in response to the actuation of a manual movement control device.

16. The device as claimed in claim 1, comprising an approximately monochromatic illumination source for illuminating the human or animal body, the device being without a closed, light-proof chamber positioned between the user and the human or animal body.

17. The device as claimed in claim 14, comprising two rigidly coupled parts extending along two perpendicular displacement axes one of the axes being raised.

18. An optical imaging method acquiring at least one image with the optical detection system of the device as defined in claim 1.

19. The method as claimed in claim 18, the image acquisition being preceded by or being simultaneous with the illumination of at least one area of the body so as to cause photoluminescence within the latter.

20. The method as claimed in claim 18, in which a topological acquisition is carried out before the optical acquisition.
